(19) United States
(12) Patent Application Publication
(10) Pub. No.: US 2026/0059552 A1
(43) Pub. Date: Feb. 26, 2026

(54) SENSING STRUCTURES AND PRIORITIZATION IN CHANNEL OCCUPANCY TIME SHARING FOR SIDELINK IN UNLICENSED SPECTRUM

(71) Applicant: QUALCOMM Incorporated, San Diego, CA (US)

(72) Inventors: Giovanni CHISCI, San Diego, CA (US); Chih-Hao LIU, San Diego, CA (US); Jing SUN, San Diego, CA (US); Stelios STEFANATOS, San Diego, CA (US); Xiaoxia ZHANG, San Diego, CA (US); Shaozhen GUO, Beijing (CN); Changlong XU, Beijing (CN)

(21) Appl. No.: 19/102,926

(22) PCT Filed: Sep. 26, 2022
(86) PCT No.: PCT/CN2022/121180

§ 371 Date: Feb. 11, 2025

(51) Int. Cl. H04W 72/25; H04W 74/0808

(52) U.S. Cl. CPC H04W 72/25; H04W 74/0808

(57) ABSTRACT

Various aspects of the present disclosure generally relate to wireless communication. In some aspects, a first user equipment (UE) may receive a channel occupancy time (COT) sharing indication from a second UE. The first UE may determine whether the COT is associated with a first channel access type or a second channel access type, wherein the first channel access type is associated with aligning sidelink transmissions across a group of UEs and the second channel access type is associated with determining a transmission starting point for a sidelink communication based at least in part on a priority associated with the first UE. The first UE may attempt to transmit a sidelink communication at the transmission starting point. Numerous other aspects are described.

### FIELD OF THE DISCLOSURE

Aspects of the present disclosure generally relate to wireless communication and to techniques and apparatuses for sensing structures and prioritization in channel occupancy time (COT) sharing for sidelink in unlicensed spectrum.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by an apparatus of a first user equipment (UE) may comprise receiving a channel occupancy time (COT) sharing indication from a second UE; determining, based at least in part on receiving the COT sharing indication, whether the COT is associated with a first channel access type or a second channel access type, wherein the first channel access type is associated with aligning sidelink transmissions across a group of UEs, and wherein the second channel access type is associated with determining a transmission starting point for a sidelink communication based at least in part on a priority associated with the first UE; and attempting to transmit a sidelink communication at the transmission starting point, wherein the transmission starting point corresponds to a common starting point utilized by the group of UEs based at least in part on the COT being associated with the first channel access type, or wherein the transmission starting point is selected from one or more transmission starting points in the COT based at least in part on the COT being associated with the second channel access type.

In some aspects, a method of wireless communication performed by an apparatus of a first UE may comprise acquiring a COT; and transmitting a COT sharing indication to a group of second UEs to enable the group of second UEs to utilize a portion of the COT, wherein the COT sharing indication indicates whether the COT is associated with a first channel access type or a second channel access type, wherein the first channel access type is associated with aligning sidelink transmissions across a group of UEs, and wherein the second channel access type is associated with determining a transmission starting point for a sidelink communication based at least in part on a priority associated with the first UE.

In some aspects, a first UE for wireless communication includes a memory and one or more processors coupled to the memory, the one or more processors configured to: receive a COT sharing indication from a second UE; determine, based at least in part on receiving the COT sharing indication, whether the COT is associated with a first channel access type or a second channel access type, wherein the first channel access type is associated with aligning sidelink transmissions across a group of UEs, and wherein the second channel access type is associated with determining a transmission starting point for a sidelink communication based at least in part on a priority associated with the first UE; and attempt to transmit a sidelink communication at the transmission starting point, wherein the transmission starting point corresponds to a common starting point utilized by the group of UEs based at least in part on the COT being associated with the first channel access type, or wherein the transmission starting point is selected from one or more transmission starting points in the COT based at least in part on the COT being associated with the second channel access type.

In some aspects, a first UE for wireless communication includes a memory and one or more processors coupled to the memory, the one or more processors configured to: acquire a COT; and transmit a COT sharing indication to a group of second UEs to enable the group of second UEs to utilize a portion of the COT, wherein the COT sharing indication indicates whether the COT is associated with a first channel access type or a second channel access type, wherein the first channel access type is associated with aligning sidelink transmissions across a group of UEs, and wherein the second channel access type is associated with determining a transmission starting point for a sidelink communication based at least in part on a priority associated with the first UE.

In some aspects, a non-transitory computer-readable medium storing a set of instructions for wireless communication includes one or more instructions that, when executed by one or more processors of a first UE, cause the first UE to: receive a COT sharing indication from a second UE; determine, based at least in part on receiving the COT sharing indication, whether the COT is associated with a first channel access type or a second channel access type, wherein the first channel access type is associated with aligning sidelink transmissions across a group of UEs, and wherein the second channel access type is associated with determining a transmission starting point for a sidelink communication based at least in part on a priority associated with the first UE; and attempt to transmit a sidelink communication at the transmission starting point, wherein the transmission starting point corresponds to a common starting point utilized by the group of UEs based at least in part on the COT being associated with the first channel access type, or wherein the transmission starting point is selected from one or more transmission starting points in the COT based at least in part on the COT being associated with the second channel access type.

In some aspects, a non-transitory computer-readable medium storing a set of instructions for wireless communication includes one or more instructions that, when executed by one or more processors of a first UE, cause the first UE to: acquire a COT; and transmit a COT sharing indication to a group of second UEs to enable the group of second UEs to utilize a portion of the COT, wherein the COT sharing indication indicates whether the COT is associated with a first channel access type or a second channel access type, wherein the first channel access type is associated with aligning sidelink transmissions across a group of UEs, and wherein the second channel access type is associated with determining a transmission starting point for a sidelink communication based at least in part on a priority associated with the first UE.

In some aspects, a first apparatus for wireless communication includes means for receiving a COT sharing indication from a second apparatus; means for determining, based at least in part on receiving the COT sharing indication, whether the COT is associated with a first channel access type or a second channel access type, wherein the first channel access type is associated with aligning sidelink transmissions across a group of apparatuses, and wherein the second channel access type is associated with determining a transmission starting point for a sidelink communication based at least in part on a priority associated with the first apparatus; and means for attempting to transmit a sidelink communication at the transmission starting point, wherein the transmission starting point corresponds to a common starting point utilized by the group of apparatuses based at least in part on the COT being associated with the first channel access type, or wherein the transmission starting point is selected from one or more transmission starting points in the COT based at least in part on the COT being associated with the second channel access type.

In some aspects, a first apparatus for wireless communication includes means for acquiring a COT; and means for transmitting a COT sharing indication to a group of second UEs to enable the group of second UEs to utilize a portion of the COT, wherein the COT sharing indication indicates whether the COT is associated with a first channel access type or a second channel access type, wherein the first channel access type is associated with aligning sidelink transmissions across a group of apparatuses, and wherein the second channel access type is associated with determining a transmission starting point for a sidelink communication based at least in part on a priority associated with the first UE.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of sidelink communications, in accordance with the present disclosure.

FIGS. 4A and 4B are diagrams illustrating an example of sidelink communications and access link communications, in accordance with the present disclosure.

FIGS. 5-9 are diagrams illustrating one or more examples of sensing structures and prioritization in channel occupancy time (COT) sharing in unlicensed spectrum, in accordance with various aspects of the present disclosure.

FIGS. 10 and 11 are diagrams illustrating example processes associated with sensing structures and prioritization in COT sharing in unlicensed spectrum, in accordance with the present disclosure.

FIGS. 12 and 13 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

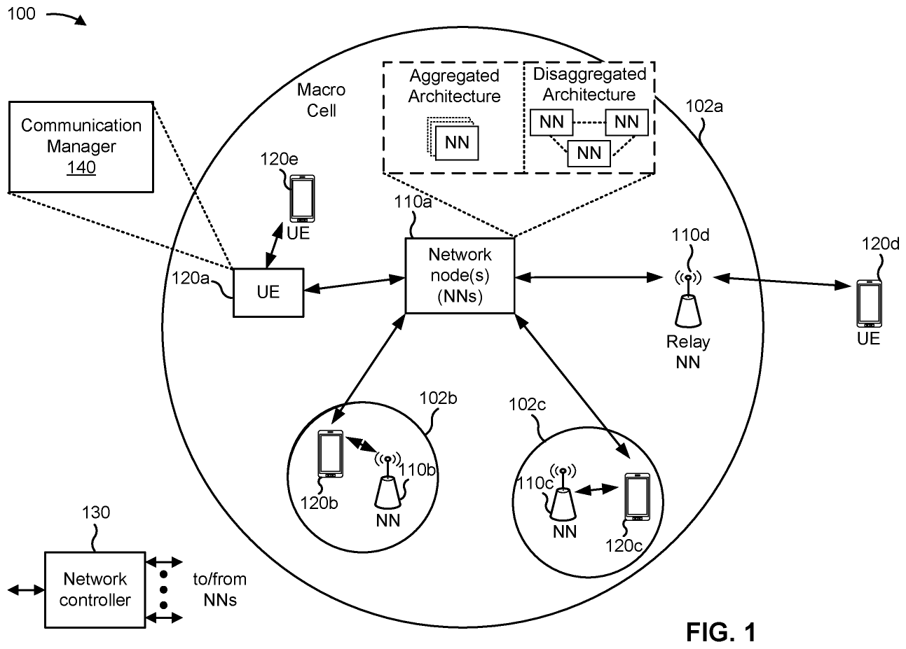

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may perform one or more operations associated with sensing structures and prioritization in channel occupancy time (COT) sharing for sidelink in unlicensed spectrum. For example, the communication manager 140 may receive a COT sharing indication from a second UE; determine, based at least in part on receiving the COT sharing indication, whether the COT is associated with a first channel access type or a second channel access type, wherein the first channel access type is associated with aligning sidelink transmissions across a group of UEs, and wherein the second channel access type is associated with determining a transmission starting point for a sidelink communication based at least in part on a priority associated with the first UE; and attempt to transmit a sidelink communication at the transmission starting point, wherein the transmission starting point corresponds to a common starting point utilized by the group of UEs based at least in part on the COT being associated with the first channel access type, or wherein the transmission starting point is selected from one or more transmission starting points in the COT based at least in part on the COT being associated with the second channel access type. Additionally, or alternatively, the communication manager 140 may perform one or more other operations described herein.

As indicated above, FIG. 1 is provided as an example. Other examples may differ from what is described with regard to FIG. 1.

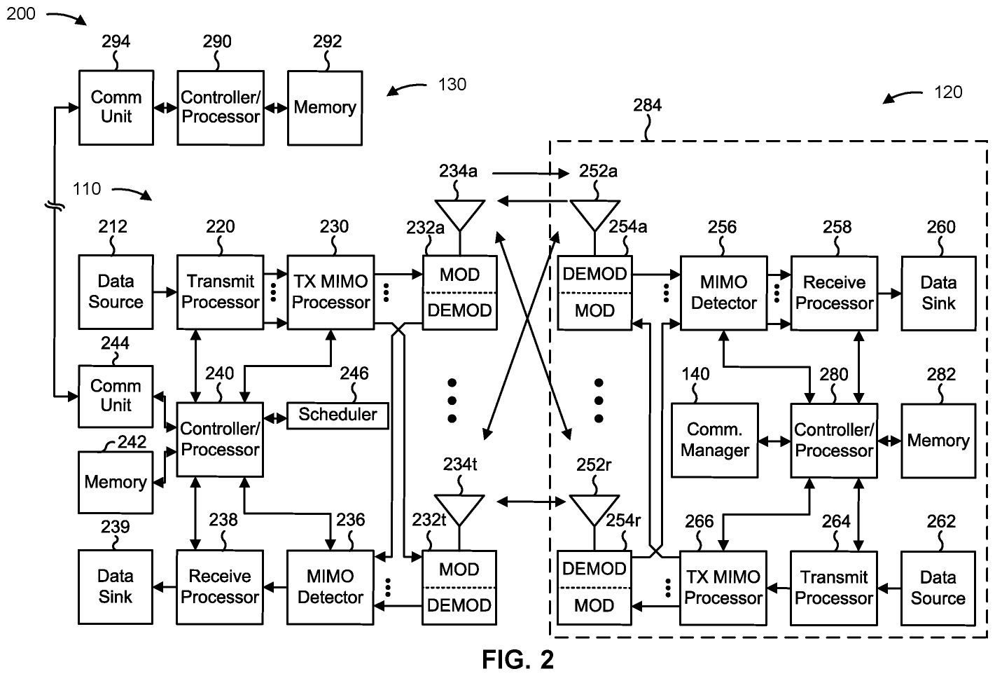

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

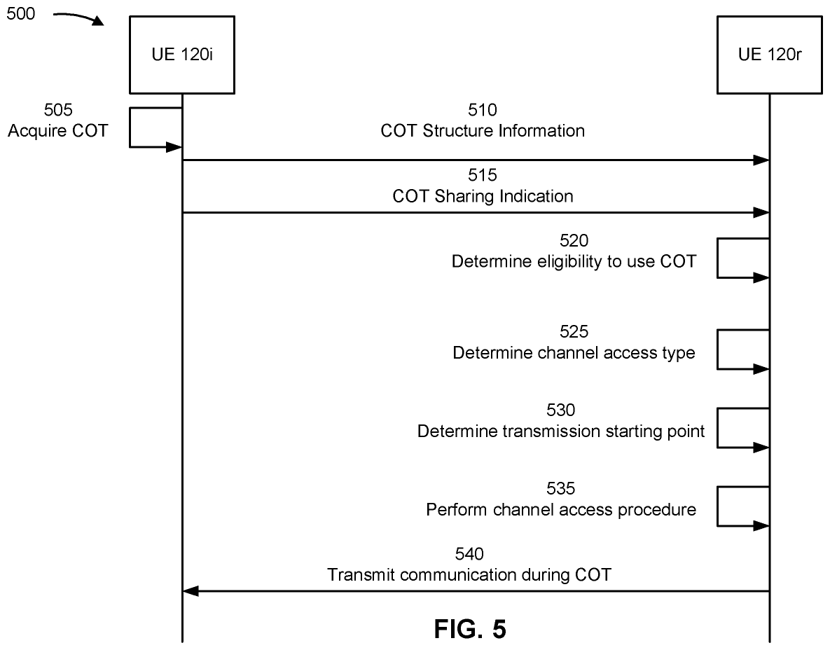

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-13).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-13).

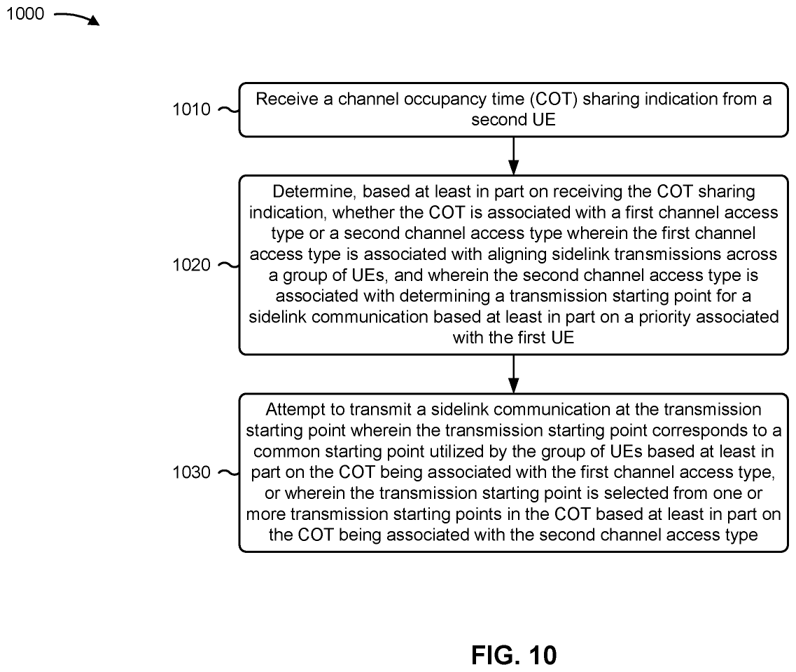

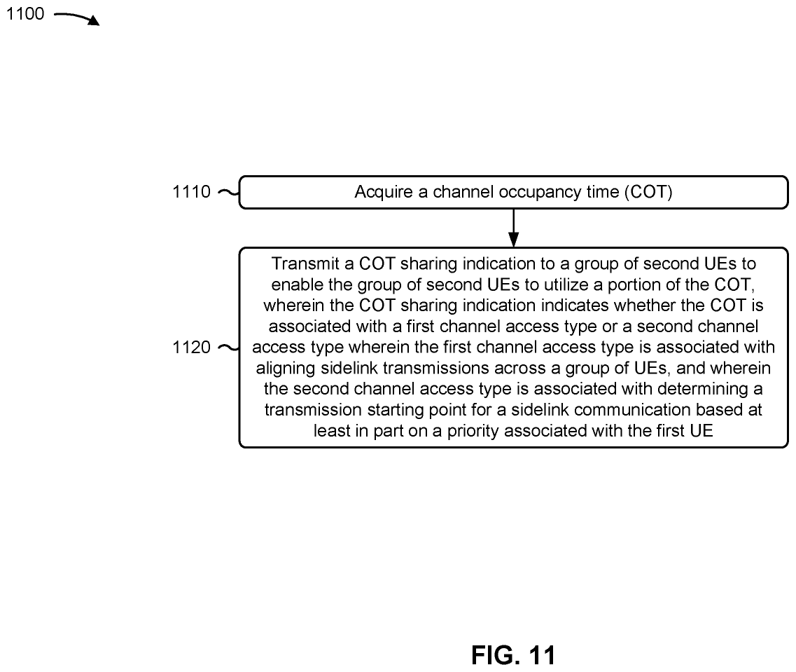

The controller/processor 240 of the network node 110, the controller/processor 280 of the UE 120, and/or any other component(s) of FIG. 2 may perform one or more techniques associated with sensing structures and prioritization in COT sharing for sidelink in unlicensed spectrum, as described in more detail elsewhere herein. For example, the controller/processor 240 of the network node 110, the controller/processor 280 of the UE 120, and/or any other component(s) of FIG. 2 may perform or direct operations of, for example, process 1000 of FIG. 10, process 1100 of FIG. 11, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, the UE 120 may include means for receiving a COT sharing indication from a second UE; means for determining, based at least in part on receiving the COT sharing indication, whether the COT is associated with a first channel access type or a second channel access type, wherein the first channel access type is associated with aligning sidelink transmissions across a group of UEs, and wherein the second channel access type is associated with determining a transmission starting point for a sidelink communication based at least in part on a priority associated with the first UE; means for attempting to transmit a sidelink communication at the transmission starting point, wherein the transmission starting point corresponds to a common starting point utilized by the group of UEs based at least in part on the COT being associated with the first channel access type, or wherein the transmission starting point is selected from one or more transmission starting points in the COT based at least in part on the COT being associated with the second channel access type, or the like. In some aspects, such means may include one or more components of UE 120 described in connection with FIG. 2, such as controller/processor 280, transmit processor 264, TX MIMO processor 266, antenna 252, modem 254, MIMO detector 256, receive processor 258, or the like.

In some aspects, the UE 120 may include means for acquiring a COT; means for transmitting a COT sharing indication to a group of second UEs to enable the group of second UEs to utilize a portion of the COT, wherein the COT sharing indication indicates whether the COT is associated with a first channel access type or a second channel access type, wherein the first channel access type is associated with aligning sidelink transmissions across a group of UEs, and wherein the second channel access type is associated with determining a transmission starting point for a sidelink communication based at least in part on a priority associated with the first UE, or the like. In some aspects, such means may include one or more components of UE 120 described in connection with FIG. 2, such as controller/processor 280, transmit processor 264, TX MIMO processor 266, antenna 252, modem 254, MIMO detector 256, receive processor 258, or the like.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

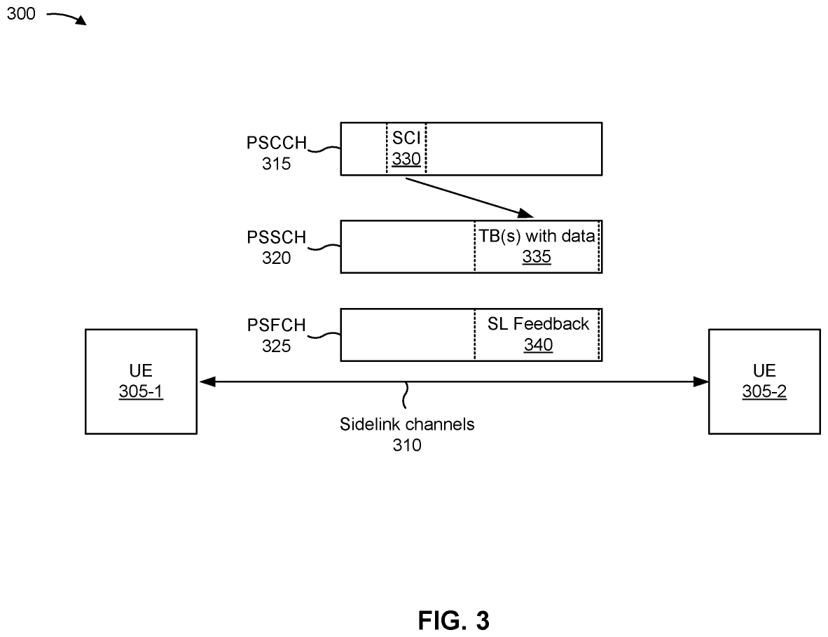

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a network node 110 via an access link or an access channel. The PSSCH 320 may be used to communicate data, similar to a physical downlink shared channel (PDSCH) and/or a physical uplink shared channel (PUSCH) used for cellular communications with a network node 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QoS) priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 320, such as a hybrid automatic repeat request (HARQ) process ID, a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a sidelink transmission mode (e.g., Mode 1) where resource selection and/or scheduling is performed by a network node 110 (e.g., a base station, a CU, or a DU). For example, the UE 305 may receive a grant (e.g., in downlink control information (DCI) or in a radio resource control (RRC) message, such as for configured grants) from the network node 110 (e.g., directly or via one or more network nodes) for sidelink channel access and/or scheduling. In some aspects, a UE 305 may operate using a transmission mode (e.g., Mode 2) where resource selection and/or scheduling is performed by the UE 305 (e.g., rather than a network node 110). In some aspects, the UE 305 may perform resource selection and/or scheduling by sensing channel availability for transmissions. For example, the UE 305 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy ratio (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or a modulation and coding scheme (MCS) to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As indicated above, FIG. 3 is provided as an example. Other examples may differ from what is described with respect to FIG. 3.

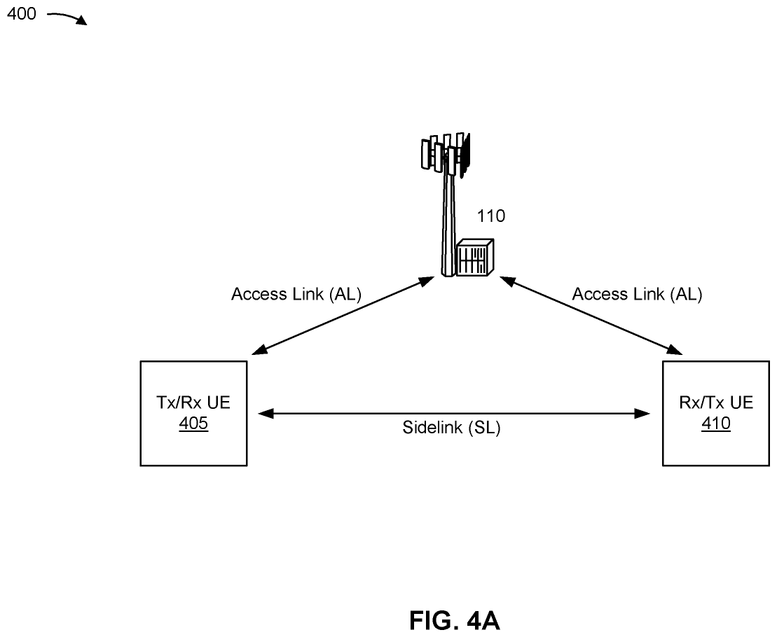

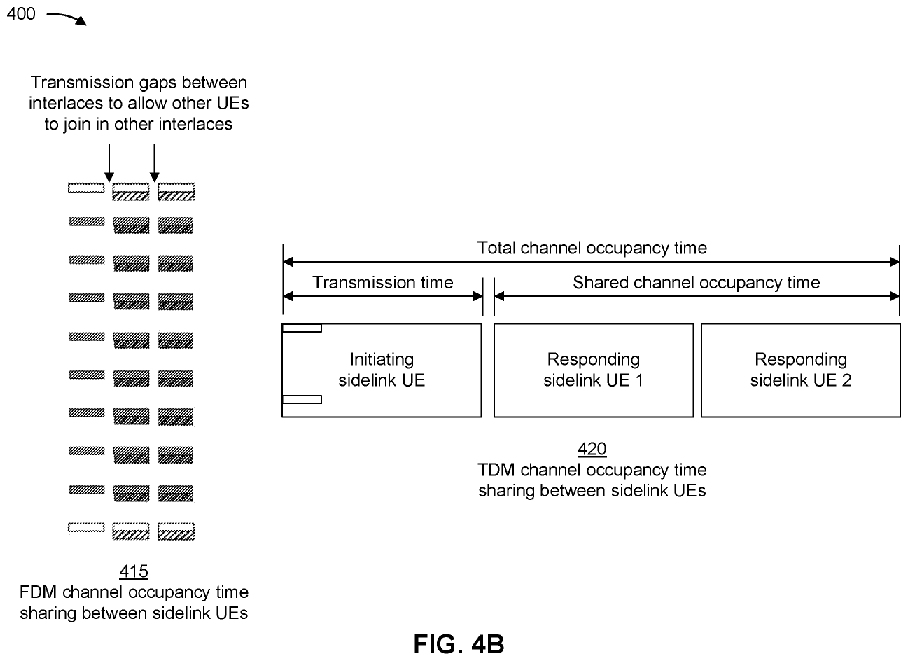

FIGS. 4A and 4B are diagrams illustrating an example 400 of sidelink communications and access link communications, in accordance with the present disclosure.

As shown in FIG. 4A, a transmitter (Tx)/receiver (Rx) UE 405 and an Rx/Tx UE 410 may communicate with one another via a sidelink, as described above in connection with FIG. 3. As further shown, in some sidelink modes, a network node 110 may communicate with the Tx/Rx UE 405 (e.g., directly or via one or more network nodes), such as via a first access link. Additionally, or alternatively, in some sidelink modes, the network node 110 may communicate with the Rx/Tx UE 410 (e.g., directly or via one or more network nodes), such as via a first access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a network 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110). Furthermore, in some aspects, sidelink communications may be transmitted via the sidelink and/or access link communications may be transmitted via the access link in a licensed radio frequency (RF) spectrum, an unlicensed RF spectrum, and/or any suitable combination thereof.

For example, to accommodate increasing traffic demands, there have been various efforts to improve spectral efficiency in wireless networks and thereby increase network capacity (e.g., via use of higher order modulations, advanced MIMO antenna technologies, multi-cell coordination techniques, and/or the like). Another way to potentially improve network capacity is to expand system bandwidth. However, available spectrum in lower frequency bands that have traditionally been licensed or otherwise allocated to mobile network operators may be limited.

Accordingly, various technologies have been developed to enable operation of a cellular radio access technology (RAT) in unlicensed or other shared spectrum. For example, Licensed-Assisted Access (LAA) uses carrier aggregation on a downlink to combine LTE in a licensed frequency band with LTE in an unlicensed frequency band (e.g., the 2.4 and/or 5 GHz bands already populated by wireless local area network (WLAN) or “Wi-Fi” devices). In other examples, Enhanced LAA (eLAA) and Further Enhanced LAA (feLAA) technologies enable both uplink and downlink LTE operation in unlicensed spectrum, MulteFire is an LTE-based technology that operates in unlicensed and shared spectrum in a standalone mode, NR-U enables NR operation in unlicensed spectrum, and/or the like. In general, when operating a cellular RAT in unlicensed spectrum (e.g., using LAA, eLAA, feLAA, MulteFire, and/or NR-U), one challenge that arises is the need to ensure fair coexistence with incumbent (e.g., WLAN) systems that may be operating in the unlicensed spectrum.

For example, prior to gaining access to and/or transmitting over an unlicensed channel, a transmitting device (e.g., network node 110, UE 120, UE 405, UE 410, and/or the like) may need to perform a listen-before-talk (LBT) procedure to contend for access to the unlicensed channel. The LBT procedure may generally include a clear channel assessment (CCA) procedure that is performed in order to determine whether the unlicensed channel is available (e.g., unoccupied by other transmitters). In particular, the CCA procedure may include detecting an energy level on the unlicensed channel and determining whether the energy level satisfies (e.g., is less than or equal to) a threshold, sometimes referred to as an energy detection threshold and/or the like. When the energy level satisfies (e.g., does not equal or exceed) the threshold, the CCA procedure is deemed to be successful and the transmitting device may gain access to the unlicensed channel for a duration that may be referred to as a channel occupancy time (COT) during which the transmitting device can perform transmissions without performing additional LBT operations. When the energy level does not satisfy the threshold, the CCA procedure is unsuccessful and contention to access the unlicensed channel may be deemed unsuccessful.

When the CCA procedure results in a determination that the unlicensed channel band is unavailable (e.g., because the energy level detected on the unlicensed channel indicates that another device is already using the channel), the CCA procedure may be performed again at a later time. In environments in which the transmitting device may obtain limited access to an unlicensed channel (e.g., due to WLAN activity or transmissions by other devices), an extended CCA (eCCA) procedure may be employed to increase the likelihood that the transmitting device will successfully obtain access to the unlicensed channel.

For example, a transmitting device performing an eCCA procedure may perform a random quantity of CCA procedures (from 1 to q), in accordance with an eCCA counter. If and/or when the transmitting device senses that the channel has become clear, the transmitting device may start a random wait period based on the eCCA counter and start to transmit if the channel remains clear over the random wait period.

Accordingly, although a wireless network can be configured to use unlicensed spectrum to achieve faster data rates, provide a more responsive user experience, offload traffic from a licensed spectrum, and/or the like, the need to ensure fair coexistence with incumbent systems (e.g., WLAN devices) may hamper efficient usage of the unlicensed spectrum. For example, even when there is no interference, the LBT procedure used to ensure that no other devices are already using the channel introduces a delay before transmissions can start, which may degrade user experience, result in unacceptable performance for latency-sensitive or delay-sensitive applications, and/or the like. Furthermore, these problems may be exacerbated when the initial CCA procedure is unsuccessful, as the transmitting device can transmit on the channel only after performing an additional quantity of CCA procedures and determining that the channel has become clear and remained clear for a random wait period. Furthermore, in some cases, the channel occupancy time obtained by a transmitting device may have a duration that is longer than necessary for the transmitting device to perform the desired transmissions, which may lead to inefficient usage of the unlicensed channel.

Accordingly, in some cases, a wireless network may enable a channel occupancy time obtained by a transmitting device to be shared with other nodes in order to improve access, efficiency, and/or the like for an unlicensed channel. For example, in downlink-to-uplink channel occupancy time sharing over an access link, a network node 110 may acquire a COT with an eCCA, and the COT may be shared with one or more UEs (e.g., UE 120, UE 405, UE 410, and/or the like) that can then transmit uplink signals within the COT acquired by the network node 110. In this case, a UE attempting to initiate an uplink transmission within the COT shared with the network node 110 can perform an uplink transmission without having to perform an LBT procedure, or the UE may perform the uplink transmission after performing a single-shot CCA with a shorter LBT procedure (e.g., a category 2 LBT procedure when the downlink-to-uplink gap duration is between 16 and 25 μs, a category 1 LBT procedure when a downlink-to-uplink gap duration is less than or equal to 16 μs, and/or the like).

Additionally, or alternatively, a wireless network may support uplink-to-downlink channel occupancy time sharing over an access link. In this case, a UE-initiated COT (e.g., for a configured grant PUSCH or a scheduled uplink transmission) can be shared with the network node 110. In this way, the network node 110 may be allowed to transmit control and/or broadcast signals and/or channels for any UE served by the network node 110, provided that the transmission contains a downlink signal, channel, and/or other transmission (e.g., a PDSCH, PDCCH, reference signal, and/or the like) intended to be received by the UE that initiated the channel occupancy.

Additionally, or alternatively, a wireless network may support UE-to-UE COT sharing over a sidelink. For example, as shown in FIG. 4B, and by reference number 415, a COT acquired by an initiating UE (e.g., UE 405) may be shared in a frequency division multiplexing (FDM) mode by dividing the COT into multiple interlaces (e.g., time periods during which one or more UEs may perform transmit operations). For example, as shown in FIG. 4B, the initiating UE may use one or more sidelink resources (e.g., time and frequency resources) to transmit in a first interlace after the COT has been acquired, and a responding UE (e.g., UE 410) may use sidelink frequency resources that are non-overlapping with sidelink frequency resources used by the initiating UE to perform transmit operations in subsequent interlaces. Accordingly, as shown in FIG. 4B, FDM or interlace-based COT sharing may introduce short transmission gaps between interlaces to allow other UEs to perform transmit operations in subsequent interlaces during a shared COT, and sidelink control information transmitted by the initiating UE may carry information to support the interlace-based COT sharing.

Additionally, or alternatively, as shown by reference number 420, UE-to-UE COT sharing may be enabled in a time division multiplexing (TDM) mode. In this case, the total COT may be divided into an initial time period during which the initiating UE may perform transmissions, which may include one or more sidelink control information transmissions that indicate when the initial transmission will end, a remaining duration of the COT that is available for sharing, and/or the like. Accordingly, one or more responding UEs may monitor the sidelink control information transmitted by other UEs (e.g., the initiating UE) to recover COT sharing information that can be used to perform transmissions during a time period that corresponds to a shared COT.

Accordingly, as described above, UE-to-UE COT sharing may enable better access to unlicensed spectrum, more efficient usage of unlicensed spectrum, and/or the like by enabling multiple UEs to perform transmissions during a COT that is obtained by an initiating UE (e.g., a UE that successfully performed an LBT procedure to acquire access to an unlicensed channel). However, in some cases, implementing UE-to-UE COT sharing may be challenging because sidelink communications generally have a rigid slot structure that provides limited opportunities (e.g., contention slots) in which another UE may perform an LBT procedure prior to transmitting. Further, in some cases, a group of UEs may attempt to access some resources in the COT, which may increase a risk of an occurrence of a collision. In some cases (e.g., when the risk of an occurrence of a collision is relatively high), it may be beneficial to implement COT sharing with TDM. In some cases (e.g., when the risk of an occurrence of a collision is relatively low), it may be beneficial to implement COT sharing with FDM.

Some aspects described herein relate to techniques and apparatuses to enable UE-to-UE channel occupancy time sharing in unlicensed spectrum by transmitting information to enable one or more responding UEs to determine whether COT sharing is implemented with a first channel access type (e.g., COT sharing with FDM) or a second channel access type (e.g., COT sharing with TDM) and/or to determine one or more other characteristics or parameters associated with utilizing the COT (e.g., a transmission starting point within the COT and/or a sensing structure, among other examples). In this way, an initiating UE may dynamically implement COT with different channel access types based at least in part on one or more network conditions (e.g., a quantity of UEs eligible to participate in COT sharing).

As indicated above, FIGS. 4A and 4B are provided as an example. Other examples may differ from what is described with respect to FIGS. 4A and 4B.

FIGS. 5-9 are diagrams illustrating one or more examples 500 of sensing structures and prioritization in COT sharing in unlicensed spectrum, in accordance with various aspects of the present disclosure. As shown in FIG. 5, example(s) 500 include an initiating UE 120i that has acquired a COT during which the UE 120i is permitted to transmit on an unlicensed channel, and a responding UE 120r communicating with the UE 120i on a sidelink via the unlicensed channel. Furthermore, as shown in FIGS. 5-9, the UE 120r may determine a channel access type and one or more transmission starting points corresponding to one or more contention slots during which the UE 120r can transmit a sidelink communication in order to share the COT acquired by the UE 120i.

As shown in FIG. 5, and by reference number 505, the UE 120i may acquire a COT during which the UE 120i is permitted to transmit over an unlicensed channel. In some aspects, the UE 120i may successfully perform an LBT procedure to acquire the COT. For example, prior to gaining access to, and transmitting over, the unlicensed channel, the UE 120i may perform the LBT procedure to contend for access to the unlicensed channel. In some aspects, the LBT procedure may include a clear channel assessment (CCA) procedure that the UE 120i performs to determine whether the unlicensed channel is available (e.g., unoccupied by other transmitters). In some aspects, the UE 120i may detect an energy level on the unlicensed channel, and the CCA procedure may be determined to be successful if the energy level on the unlicensed channel satisfies (e.g., is less than or equal to) a threshold. In such cases, the UE 120i may gain access to the unlicensed channel to acquire the COT during which the UE 120i can perform transmissions without performing additional LBT operations.

In cases where the energy level detected on the unlicensed channel fails to satisfy (e.g., is greater than or equal to the threshold), the CCA procedure may be determined to be unsuccessful and the UE 120i may perform the CCA procedure again and acquire the COT at a later time. Additionally, or alternatively, the UE 120i may acquire the COT by performing another type of channel access procedure. For example, the UE 120i may acquire the COT by performing an extended CCA (eCCA) procedure.

As shown by reference number 510, the UE 120r may receive COT structure information. For example, the UE 120i may transmit COT structure information based at least in part on acquiring the COT. The COT structure information may indicate a resource structure (e.g., time resources and/or frequency resources) of the COT.

As shown by reference number 515, the UE 120i may transmit, and the UE 120r may receive, a COT sharing indication to enable the sharing of the COT acquired by the UE 120i. In some aspects, the COT sharing indication may be included in sidelink control information (e.g., SCI-1 or SCI-2) transmitted by the UE 120i to a group of one or more UEs (e.g., a group of Ues that includes the UE 120r).

In some aspects, the COT sharing indication may indicate a channel access type associated with the COT. For example, the COT sharing indication may indicate whether the COT is associated with a first channel access type (e.g., COT sharing with FDM) or a second channel access type (e.g., COT sharing with TDM).

In some aspects, the COT sharing indication may include a direct indication of the channel access type associated with the COT. In some aspects, the COT sharing indication may indicate the channel access type based at least in part on a presence or an absence of a direct indication of the channel access type (e.g., a presence or absence of a flag, a set of one or more bits, and/or another type of direct indication of the channel access type). For example, the COT may be associated with the first channel access type when the COT sharing indication includes a flag, a set of one or more bits, or another type of indicator, and the COT may be associated with the second channel access type when the COT sharing indication does not include an indication of the channel access type associated with the COT.

As another example, the COT sharing indication may include a set of one or more bits to indicate the channel access type associated with the COT. In some aspects, the set of bits may be set to a first value (e.g., 0) to indicate that the COT is associated with the first channel access type, and may be set to a second value (e.g., 1) to indicate that the COT is associated with the second channel access type.

In some aspects, a value of the set of bits may indicate an entry in a table. For example, the UE 120r may maintain a plurality of tables associated with COT sharing. Each table may include a plurality of entries indicating a channel access type, a transmission starting point, a priority associated with a transmission starting point, a cyclic prefix extension, an automatic gain control puncturing value, and/or a sensing duration for a channel access procedure associated with the COT, among other examples. The UE 120r may determine a table and/or an entry associated with the COT based at least in part on the set of bits.

For example, a first bit, of the set of bits, may indicate a table, of the plurality of tables, maintained by the UE 120r. A second bit, of the set of bits, may indicate a row of the table and a third bit, of the set of bits, may indicate a column of the table. The UE 120r may determine the channel access type associated with the COT based at least in part on the entry corresponding to the column and row of the table indicated by the set of bits. In some aspects, the presence of the set of bits in the COT sharing indication may indicate that the COT is associated with the first channel access type, and the absence of the set of bits may indicate that the COT is associated with the second channel access type.

In some aspects, the COT sharing indication may indirectly indicate the channel access type associated with the COT. For example, as described in greater detail below, the COT sharing indication may include additional information associated with the COT that can be utilized by the UE 120r to determine whether the COT is associated with the first channel access type or the second channel access type.

As shown by reference number 520, the UE 120r may determine whether the UE 120r is eligible to use the COT based at least in part on receiving the COT sharing indication. In some aspects, the UE 120r may determine whether the UE 120r is eligible to use the COT based at least in part on whether the UE 120r is a target of at least a PSSCH of the UE 120i. For example, the UE 120r may determine that the UE 120r is eligible to use the COT when the UE 120r receives a PSSCH from the UE 120i during a first or unshared portion of the COT.

In some aspects, the UE 120r may determine whether the UE 120r is eligible to use the COT based at least in part on whether the UE 120r is a target of a transmission of the UE 120i. For example, the UE 120r may determine that the UE 120r is eligible to use the COT when an identifier associated with the UE 120r is included in a destination ID field of the COT sharing indication.

In some aspects, the UE 120r may determine whether the UE 120r is eligible to use the COT based at least in part on a priority indicated in the COT sharing indication and/or a priority of a transmission of the UE 120r. For example, the UE 120r may determine that the UE 120r is eligible to use the COT to transmit a particular transmission when a priority associated with the particular transmission is greater than or equal to a priority indicated in the COT sharing indication.

In some aspects, the UE 120r may determine whether the UE 120r is eligible to use the COT based at least in part on whether the COT is to be utilized for a transmission to the UE 120i. For example, the UE 120r may determine that the UE 120r is eligible to use the COT when the UE 120r is to use the COT to transmit a transmission to the UE 120i.

As shown by reference number 525, the UE 120r may determine a channel access type associated with the COT based at least in part on determining that the UE 120r is eligible to use the COT. In some aspects, the UE 120r may determine the channel access type based at least in part on the COT sharing indication.

In some aspects, the COT sharing indication may include a direct indication of the channel access type associated with the COT. For example, the COT sharing indication may include a flag, a set of one or more bits, and/or another type of indicator indicating the channel access type associated with the COT.

In some aspects, the UE 120r may determine the channel access type based at least in part on a presence or an absence of the direct indication of the channel access type (e.g., a presence or absence of a flag, a set of one or more bits, and/or another type of direct indication of the channel access type). For example, the UE 120r may determine that the COT is associated with the first channel access type when the COT sharing indication includes a flag, a set of one or more bits, or another type of indicator. The UE 120r may determine that the COT is associated with the second channel access type when the COT sharing indication does not include a direct indication of the channel access type associated with the COT.

In some aspects, the COT sharing indication may include a set of one or more bits and the UE 120r may determine the channel access type associated with the COT based at least in part on the set of bits. In some aspects, the UE 120r may determine that the COT is associated with the first channel access type based at least in part on the set of bits being set to a first value (e.g., 0). In some aspects, the UE 120r may determine that the COT is associated with the second channel access type based at least in part on the set of bits being set to a second value (e.g., 1).

In some aspects, the value of the set of bits may indicate an entry in a table. The UE 120r may determine the channel access type associated with the COT based at least in part on information included in the entry. For example, the UE 120r may determine the table, the entry, and/or the channel access type associated with the COT in a manner similar to that described above.

In some aspects, the COT sharing indication may include an indirect indication of the channel access type associated with the COT. For example, the COT sharing indication may include additional information associated with the COT and the UE 120r may determine the channel access type associated with the COT based at least in part on the additional information.

In some aspects, the additional information may include information indicating a quantity of UEs associated with the COT and the UE 120r may determine the channel access type associated with the COT based at least in part on the quantity of UEs. For example, the UE 120r may determine whether the quantity of UEs associated with the COT satisfies (e.g., is greater than) a threshold. The UE 120r may determine that the COT is associated with the second channel access type when the quantity of UEs associated with the COT satisfies the threshold. The UE 120r may determine that the COT is associated with the second channel access type when the quantity of UEs associated with the COT fails to satisfy the threshold.

In some aspects, the quantity of UEs associated with the COT corresponds to a quantity of UEs indicated in the COT sharing indication. For example, the COT sharing indication may include identifiers associated with a group of UEs that may share the COT. The UE 120r may determine the channel access type associated with the COT based at least in part on whether the quantity of UEs included in the group of UEs satisfies the threshold.

In some aspects, the quantity of UEs associated with the COT corresponds to a quantity of UEs to which the COT sharing indication is transmitted. For example, the COT sharing indication may indicate a group of UEs to which the COT sharing indication is transmitted (e.g., the COT may include a group of destination addresses for the group of UEs). The UE 120r may determine the channel access type associated with the COT based at least in part on whether the quantity of UEs included in the group of UEs to which the COT is transmitted satisfies the threshold.

In some aspects, the UE 120r may determine the channel access type associated with the COT based at least in part on whether the COT is associated with a resource reservation. For example, the UE 120r may determine that the COT is associated with the first channel access type when one or more resources of the COT that may be utilized by the UE 120r are associated with a resource reservation (e.g., when another UE transmits sidelink control information reserving one or more resources that are included in a portion of the COT that may be shared by the group of UEs to which the COT sharing indication is transmitted).

As shown by reference number 530, the UE 120r may determine a transmission starting point based at least in part on the channel access type. The transmission starting point may correspond to a start of a portion of the COT that can be utilized by the UE 120r for sidelink communications.

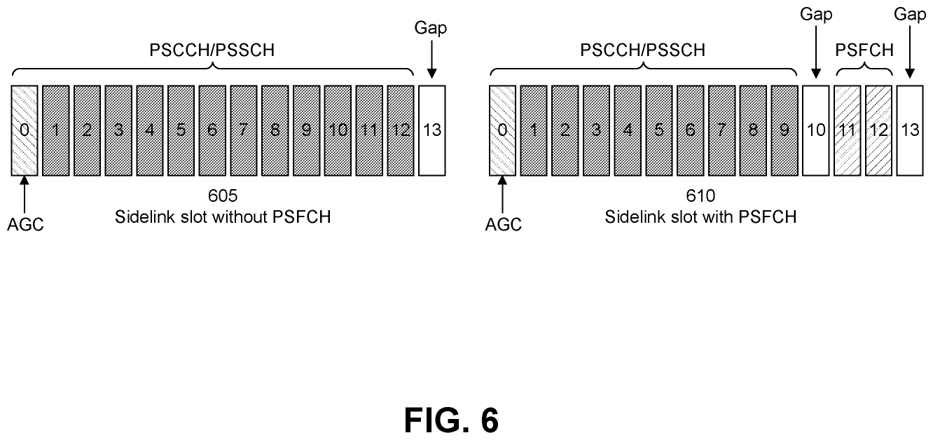

For example, as shown in FIG. 6, a sidelink slot structure 605 without a physical sidelink feedback channel (PSFCH) may include fourteen (14) symbols total, with thirteen (13) symbols indexed from zero (0) to twelve (12) available for physical sidelink control channel (PSCCH) and/or physical sidelink shared channel (PSSCH) transmissions and a final symbol (index thirteen (13)) in the slot left as a gap during which no transmissions are performed. Furthermore, as shown in FIG. 6, the first symbol is used for AGC training, whereby the second symbol (symbol 1) is a repetition of the first symbol (symbol 0) to increase reliability for the PSCCH and/or PSSCH transmission (e.g., because the receiving UE may be unable to properly receive and/or decode the first symbol prior to performing AGC training). Alternatively, a sidelink slot structure 610 with a PSFCH may include fourteen (14) symbols total, with ten (10) symbols indexed from zero (0) to nine (9) available for PSCCH and/or PSSCH transmissions, two symbols indexed eleven (11) and twelve (12) used for repetitions of a PSFCH symbol, and two symbols indexed ten (10) and thirteen (13) left as gaps during which no transmissions are performed. Regardless of whether the sidelink slot structure includes PSFCH symbols, the last symbol in a slot is a gap symbol and the first symbol in a slot is an automatic gain control (AGC) symbol, which is a repetition of the second symbol.

Accordingly, in some aspects, the UE 120r may determine the transmission starting point, which may represent a start of a possible time when the UE 120r can start a transmission in the COT shared by the UE 120i, within a joint period that includes the last symbol (symbol 13) in a current slot (e.g., a slot prior to the transmission) and the first symbol (symbol 0) in a next slot (e.g., a slot in which the UE 120r is to perform the transmission).

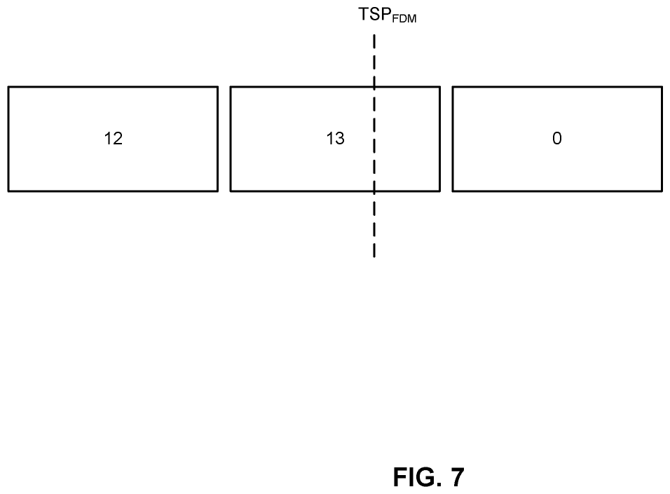

In some aspects, the COT may be associated with the first channel access type (e.g., COT with FDM) and the UE 120r may determine a common or default transmission starting point based at least in part on the COT being associated with the first channel access type. For example, as shown in FIG. 7, the COT (e.g., the gap symbol (symbol 13)) may be associated with a common or default transmission starting point (TSP_{FDM}). The UE 120r may identify the common or default transmission starting point as the transmission starting point based at least in part on the COT being associated with the first channel access type.

In some aspects, the COT may be configured with multiple common or default transmission starting points. Each common or default transmission starting point may be associated with a priority. In some aspects, each common or default transmission starting point may be associated with the same priority. In some aspects, one or more of the multiple common or default transmission starting points may be associated with a priority that is different than a priority associated with another one of the multiple common or default transmission starting points.

In some aspects, the COT sharing indication may indicate a priority associated with the COT and the UE 120r may determine the common or default transmission starting point, of the multiple common or default transmission starting points, based at least in part on the priority associated with the COT. For example, the UE 120r may maintain a mapping of priorities to transmission starting points and may utilize the mapping to identify the common or default transmission starting point associated with the same priority as the priority associated with the COT as the transmission starting point.

In some aspects, the UE 120r may receive the mapping from a network node. For example, the mapping may be received from a network node (e.g., network node 110) via radio resource control (RRC) signaling. Additionally, or alternatively, the mapping may be hardcoded and/or maintained in a memory of the UE 120r.

In some aspects, the UE 120r may determine the common or default transmission starting point based at least in part on a priority associated with a transmission of the UE 120r. For example, the UE 120r may maintain a mapping of priorities of transmissions by the UE 120r to transmission starting points. The UE 120r may utilize the mapping to determine a common or default transmission starting point associated with the same priority as a priority associated with a transmission of the UE 120r.

In some aspects, the UE 120r may determine the transmission starting point based at least in part on the COT being associated with the first channel access type and based at least in part on the COT being associated with a resource reservation. In some aspects, the UE 120r may determine that the COT is associated with a resource reservation based at least in part on receiving SCI transmitted by another UE. The SCI may indicate a resource reservation for a resource included in the COT.

In some aspects, the SCI indicates the transmission starting point. For example, the SCI may indicate a starting point of the resource reservation and the UE 120r may identify the starting point of the resource reservation as the transmission starting point.

In some aspects, the SCI may include a set of one or more bits and the UE 120r may determine the starting point of the resource reservation based at least in part on the set of one or more bits. In some aspects, the set of one or more bits may indicate an index associated with the starting point of the resource reservation and the UE 120r may determine the starting point of the resource reservation, and therefore, the transmission starting point, based at least in part on the index.

In some aspects, the set of one or more bits may indicate an entry in a table. The UE 120r may identify the entry based at least in part on the set of one or more bits. The entry may include information indicating the transmission starting point and/or the starting point of the resource reservation, and the UE 120r may determine the transmission starting point based at least in part on the information included in the entry.

In some aspects, the SCI may indicate a priority associated with the resource reservation (e.g., the SCI may indicate a Layer 1 (L1) priority and/or a channel access priority class (CAPC) value, among other examples) and the UE 120r may determine the transmission starting point based at least in part on the priority. For example, the UE 120r may maintain a mapping of CAPC values to transmission starting points. The UE 120r may utilize the mapping to determine a transmission starting point associated with a CAPC value indicated in the SCI.

In some aspects, the UE 120r may determine the transmission starting point based at least in part on a quantity of subchannels associated with the resource reservation. For example, the UE 120r may determine that the transmission starting point corresponds to a default transmission starting point associated with the COT based at least in part on a quantity of allocated subchannels associated with the resource reservation being less than a quantity of subchannels included in a resource block set of the COT.

In some aspects, the UE 120r may determine the common or default transmission starting point based at least in part on a reference transmission. In some aspects, the reference transmission may be a transmission of the UE 120i. For example, the UE 120r may determine the common or default transmission starting point based at least in part on an end of a transmission of the UE 120i. In some aspects, the UE 120r may select a common or default transmission starting point that occurs a period of time (X μs) after an end of the transmission of the UE 120i.

In some aspects, the period of time X μs may be configured by the UE 120i. For example, a COT sharing indication may indicate the period of time X μs. Additionally, or alternatively, the period of time X μs may be configured by a network node (e.g., a network node 110).

In some aspects, the reference transmission may be a response to a transmission of the UE 120i. For example, the UE 120r may determine the common or default transmission starting point based at least in part on an end of a transmission of a response to a transmission of the UE 120i. In some aspects, the UE 120r may select a common or default transmission starting point that occurs a period of time (Y μs) after an end of a transmission of a response to a transmission of the UE 120i.

In some aspects, the period of time Y μs may be configured by the UE 120i. For example, a COT sharing indication may indicate the period of time Y μs. Additionally, or alternatively, the period of time Y μs may be configured by a network node (e.g., a network node 110).

In some aspects, the period of time Y μs may be the same as the period of time X μs. In some aspects, the period of time Y μs may be different from the period of time X μs.

In some aspects, the UE 120r may determine a UE that is to transmit a response to the UE 120i based at least in part on sidelink control information transmitted by the UE 120i. For example, the UE 120r may decode a destination ID field of sidelink control information transmitted by the UE 120i. The UE 120r may detect a transmission to the UE 120i from a UE indicated by the destination ID field. The UE 120r may determine the common or default transmission starting point based at least in part on an end of the transmission to the UE 120i from the UE indicated by the destination ID field.

In some aspects, the UE 120r may determine the common or default transmission starting point based at least in part on an amount of time associated with the UE 120r decoding the COT sharing indication. In some aspects, the UE 120r may finish decoding the COT sharing indication and/or determining the common or default transmission starting point after an occurrence of the common or default transmission starting point. The UE 120r may select another common or default transmission starting point, from the multiple common or default transmission starting points associated with the COT, based at least in part on the UE 120r finishing decoding the COT sharing indication and/or determining the transmission starting point after the occurrence of the common or default transmission starting point.

In some aspects, the UE 120r's other common or default transmission starting point may be a next occurring common or default transmission starting point. In some aspects, the other common or default transmission starting point may be a next occurring common or default transmission starting point that is associated with a priority that is the same as, or a lower priority relative to, a priority associated with a transmission of the UE 120r.

In some aspects, the UE 120r may finish decoding the COT sharing indication and/or determining the common or default transmission starting point prior to an occurrence of the common or default transmission starting point but without sufficient time to perform a channel access procedure prior to the transmission starting point. For example, the COT may be associated with a channel access procedure that requires application of a minimum amount of sensing (e.g., for 25 μs). The UE 120r may finish decoding the COT sharing indication and/or determining the common or default transmission starting point prior to an occurrence of the common or default transmission starting point but without sufficient time to apply the minimum amount of sensing.

The UE 120r may select another common or default transmission starting point, from the multiple common or default transmission starting points associated with the COT, that provides the UE 120r with a sufficient amount of time to perform the channel access procedure. In some aspects, the UE 120r may select the other common or default transmission starting point based at least in part on a mapping (e.g., a mapping of priorities to common or default transmission starting points) that is different from a mapping utilized to determine the initial common or default transmission starting point.

In some aspects, the mapping used to determine the other transmission starting point may be configured to map the priority to a transmission starting point occurring at least a minimum amount of time after an end of a reference transmission. In some aspects, the minimum amount of time may be greater than the amount of time associated with performing the channel access procedure.

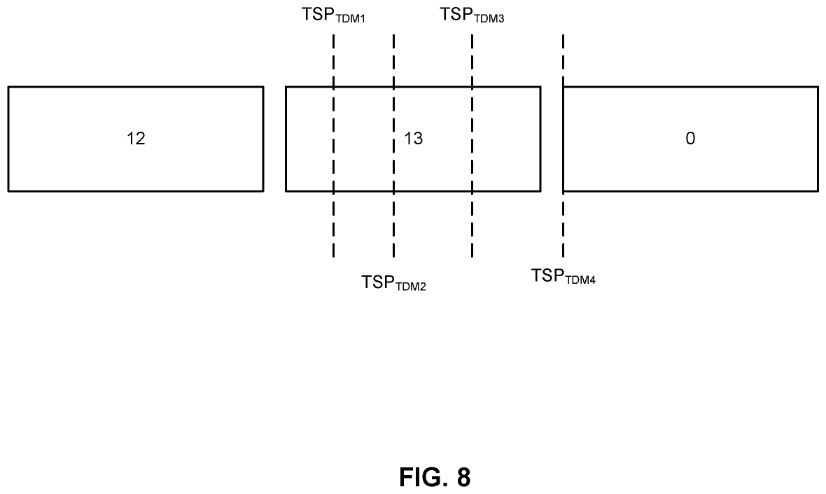

In some aspects, the COT may be associated with the second channel access type (e.g., COT with TDM) and the UE 120r may select the transmission starting point from a group of transmission starting points based at least in part on the COT being associated with the second channel access type. For example, as shown in FIG. 8, the COT (e.g., the gap symbol (symbol 13)) may be configured with a group of transmission starting points (TSP_{TDM1}, TSP_{TDM2}, TSP_{TDM3}, and TSP_{TDM4}, as shown).

In some aspects, the UE 120r may determine the group of transmission starting points configured for the COT based at least in part on a transmission starting point configuration. For example, the UE 120r may receive (e.g., from a network entity 110 and/or the UE 120i) and/or store in a memory of the UE 120r one or more transmission starting point configurations associated with the COT.

In some aspects, the UE 120r may select the transmission starting point from the group of transmission starting points based at least in part on a quantity of priorities indicated in the COT sharing indication. For example, the COT sharing indication may include a set of one or more bits, and a value of the one or more bits may correspond to a quantity of priorities associated with the group of transmission starting points. The UE 120r may determine a priority associated with each transmission starting point based at least in part on the quantity of priorities associated with the group of transmission starting points.

For example, the set of one or more bits may be set to a first value (e.g., 1) to indicate that each transmission starting point, of the group of transmission starting points, is associated with a same priority (e.g., a highest priority). As another example, the one or more bits may be set to a second value (e.g., 2) to indicate that a first half of the transmission starting points (e.g., TSP_{TDM1} and TSP_{TDM2}) are associated with a first priority (e.g., a highest priority) and that a second half of the transmission starting points (e.g., TSP_{TDM3} and TSP_{TDM4}) are associated with a second priority (e.g., a next highest priority).

In some aspects, the UE 120r may select the transmission starting point based at least in part on a mapping. For example, the UE 120r may maintain a mapping of priorities associated with transmissions of the UE 120r to transmission starting points included in the group of transmission starting points. The UE 120r may utilize the mapping to determine a transmission starting point associated with a same priority as a priority of a transmission of the UE 120r.

In some aspects, the UE 120r may maintain a plurality of mappings. The UE 120r may determine a mapping, of the plurality of mappings, to be utilized to determine the transmission starting point associated with a same priority as a priority of a transmission of the UE 120r based at least in part on an indication included in the COT sharing indication, a priority associated with the COT, and/or a priority associated with the transmission of the UE 120r, among other examples.

In some aspects, the UE 120r may receive the mapping (and/or one or more of the plurality of mappings) from a network node. For example, the mapping may be received from a network node (e.g., network node 110) via radio resource control (RRC) signaling. Additionally, or alternatively, the mapping may be hardcoded and/or maintained in a memory of the UE 120r.

In some aspects, the UE 120r may determine the transmission starting point based at least in part on a reference transmission. In some aspects, the reference transmission may be a transmission of the UE 120i. For example, the UE 120r may determine the transmission starting point based at least in part on an end of a transmission of the UE 120i, in a manner similar to that described above.

In some aspects, the reference transmission may be a response to a transmission of the UE 120i. For example, the UE 120r may determine the transmission starting point based at least in part on an end of a transmission of a response to a transmission of the UE 120i, in a manner similar to that described above.

In some aspects, the UE 120r may determine the transmission starting point based at least in part on an amount of time associated with the UE 120r decoding the COT sharing indication. In some aspects, the UE 120r may finish decoding the COT sharing indication and/or determining the transmission starting point after an occurrence of the transmission starting point. The UE 120r may select another transmission starting point, from the group of transmission starting points, based at least in part on the UE 120r finishing decoding the COT sharing indication and/or determining the transmission starting point after the occurrence of the transmission starting point, in a manner similar to that described above.

In some aspects, the UE 120r's other transmission starting point may be a next occurring transmission starting point. In some aspects, the other transmission starting point may be a next occurring transmission starting point that is associated with a priority that is the same as, or a lower priority relative to, a priority associated with a transmission of the UE 120r.

In some aspects, the UE 120r may finish decoding the COT sharing indication and/or determining the transmission starting point prior to an occurrence of the transmission starting point but without sufficient time to perform a channel access procedure prior to the transmission starting point. For example, the COT may be associated with a channel access procedure that requires application of a minimum amount of sensing (e.g., for 25 μs). The UE 120r may finish decoding the COT sharing indication and/or determining the transmission starting point prior to an occurrence of the transmission starting point but without sufficient time to apply the minimum amount of sensing.

The UE 120r may select another transmission starting point, from the group of transmission starting points, that provides the UE 120r with a sufficient amount of time to perform the channel access procedure. In some aspects, the UE 120r may select the other transmission starting point based at least in part on a mapping (e.g., a mapping of priorities to transmission starting points) that is different from a mapping utilized to determine the initial transmission starting point.

In some aspects, the mapping used to determine the other transmission starting point may be configured to map the priority to a transmission starting point occurring at least a minimum amount of time after an end of a reference transmission. In some aspects, the minimum amount of time may be greater than the amount of time associated with performing the channel access procedure.

As shown in FIG. 5, and by reference number 535, the UE 120r may perform a channel access procedure based at least in part on determining the transmission starting point. In some aspects, the UE 120r may perform a channel access procedure based at least in part on a sensing structure associated with the transmission starting point.

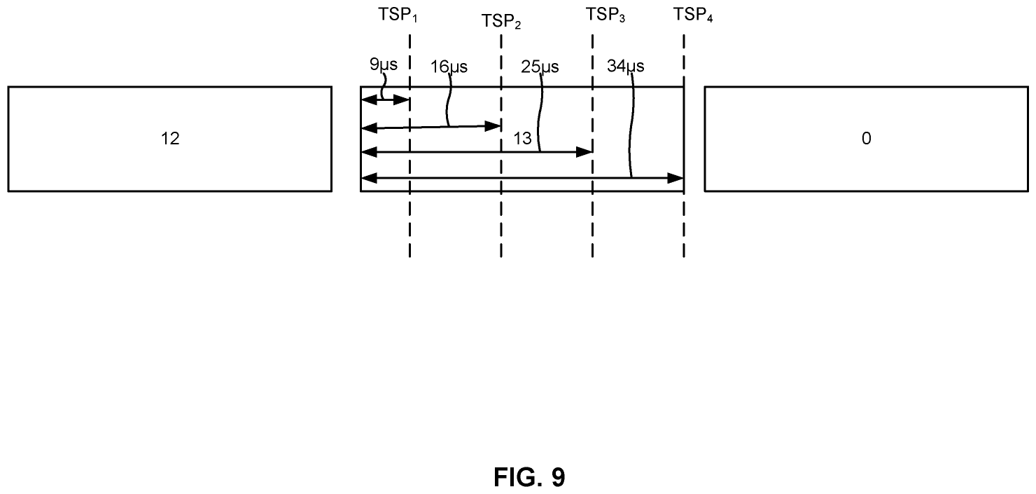

In some aspects, the sensing structure associated with a transmission staring point may be determined based at least in part on an amount of time between an end of a reference transmission and the transmission starting point. In some aspects, a transmission starting point may be associated with Type 2C channel access when the amount of time between the transmission starting point and an end of a reference transmission is less than a first amount of time (e.g., less than 16 μs) and a duration of a transmission is less than a second amount of time (e.g., 584 μs). For example, as shown in FIG. 9, an amount of time between an end of a reference transmission (e.g., a start of symbol 13) and a first transmission starting point (TSP₁) is 9 μs. The UE 120r may determine that 9 μs is less than the first amount of time. The UE 120r may determine that the first transmission starting point is associated with Type 2C channel access based at least in part on 9 μs being less than the first amount of time and when a duration of a transmission of the UE 120r is within the second amount of time.

In some aspects, the transmission starting point may be associated with Type 2B channel access when the amount of time between the transmission starting point and the end of the reference transmission point is equal to the first amount of time. For example, as shown in FIG. 9, an amount of time between an end of the reference transmission and a second transmission starting point (TSP₂) is 16 μs. The UE 120r may determine that the second transmission starting point is associated with Type 2B channel access based at least in part on the amount of time between the second transmission staring point and the end of the reference transmission being equal to the first amount of time.

In some aspects, the transmission starting point may be associated with Type 2A channel access when the amount of time between the transmission starting point and the end of the reference transmission point is equal to a third amount of time (e.g., 25 μs). For example, as shown in FIG. 9, an amount of time between an end of the reference transmission and a third transmission starting point (TSP₃) is 25 μs. The UE 120r may determine that the third transmission starting point is associated with Type 2A channel access based at least in part on the amount of time between the third transmission staring point and the end of the reference transmission being equal to the third amount of time.

In some aspects, for a subsequent transmission starting point (e.g., TSPᵢ), the UE 120r may utilize Type 2A channel access before a time (tᵢ) corresponding to an occurrence of the subsequent transmission point. The time (tᵢ) may correspond an amount of time between the third transmission point and the end of the reference transmission (e.g., 25 μs) plus an amount of time (xᵢ). The amount of time (xᵢ) may correspond to an amount of time between the third transmission starting point and the subsequent transmission starting point.

In some aspects, for subsequent transmission starting points, the UE 120r may determine that the subsequent transmission starting point is associated with Type 2A channel access plus i−3 contention slots of 9 μs when the amount of time (xᵢ) is equal to (i−3)×9 μs. As an example, for the fourth transmission starting point i is equal to 4. The UE 120r may determine that the fourth transmission starting point is associated with Type 2A channel access plus 1 (e.g., i−3) contention slot of 9 μs based on the amount of time (xᵢ) (e.g., 9 us between the third transmission point and the fourth transmission point) being equal to (4−3)×9 μs (e.g., 9 μs).

In some aspects, the UE 120r may determine the sensing structure associated with a transmission starting point based at least in part on whether the transmission starting point is an initial transmission starting point (e.g., a transmission starting point determined prior to the occurrence of the transmission starting point and with sufficient time to perform the channel access procedure) or a next or later transmission starting point (e.g., a transmission starting point that is determined based at least in part on determining the initial transmission starting point after an occurrence of the initial transmission starting point or prior to the occurrence of the initial transmission starting point but without sufficient time to perform the channel access procedure).

In some aspects, the UE 120r may determine the sensing structure associated with an initial transmission point in a manner similar to that described above. In some aspects, for a next or later transmission starting point, the UE 120r may determine to use Type 2A channel access prior to a time of the next or later transmission starting point. In some aspects, the UE 120r may determine to use Type 2A channel access prior to a time (tᵢ) of an occurrence of the next or later transmission point (tᵢ) based at least in part on the time (tᵢ) being equal to (i−1)×xᵢ μs.

In some aspects, the UE 120r may apply sensing prior to a start of the gap symbol based at least in part on the transmission starting point being a next or later transmission starting point. In some aspects, the UE 120r may determine to use Type 2A channel access prior to the gap symbol plus i−1 contention slots of 9 μs when xᵢ is equal to (i−1)×9 μs.

In some aspects, the UE 120r may determine to apply sensing starting from a start of the gap symbol based at least in part on the time (tᵢ) being equal to 25+(i−1)×xᵢ μs. In some aspects, the UE 120r may use Type 2A channel access any time prior to the time (tᵢ). In some aspects, the UE 120r may use Type 2A access plus i−1 contention slots of 9 μs when xᵢ is equal to 25+(i−1)×9 μs.

As shown in FIG. 5, and by reference number 540, the UE 120r may transmit a communication during the COT based at least in part on performing the channel access procedure. For example, the UE 120r may transmit a communication during the COT based at least in part on determining that the COT is available based at least in part on a CCA procedure being determined to be successful, as described elsewhere herein.

As indicated above, FIGS. 5-9 are provided as an example. Other examples may differ from what is described with respect to FIGS. 5-9.

FIG. 10 is a diagram illustrating an example process 1000 performed, for example, by a first UE, in accordance with the present disclosure. Example process 1000 is an example where the first UE (e.g., UE 120r) performs operations associated with sensing structures and prioritization in COT sharing for sidelink in unlicensed spectrum.

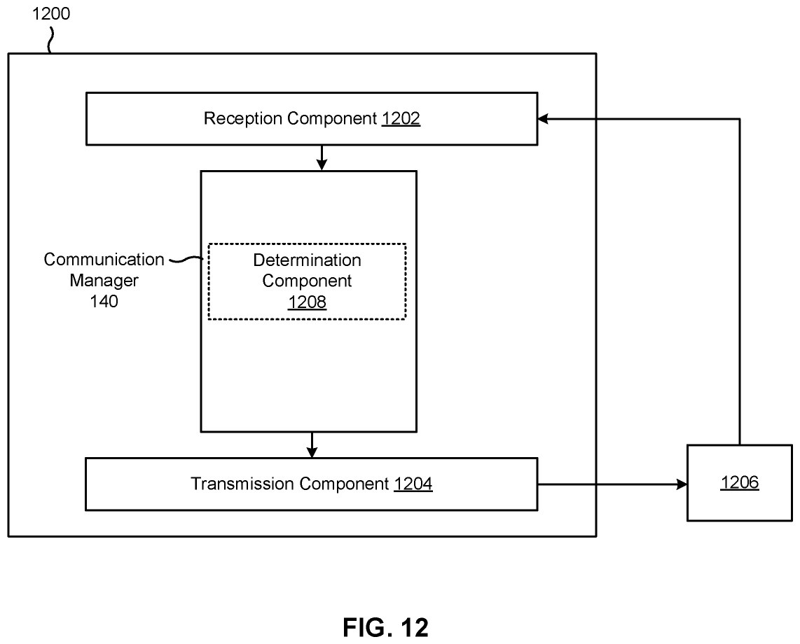

As shown in FIG. 10, in some aspects, process 1000 may include receiving a COT sharing indication from a second UE (block 1010). For example, the first UE (e.g., using communication manager 140 and/or reception component 1202, depicted in FIG. 12) may receive a COT sharing indication from a second UE, as described above.

As further shown in FIG. 10, in some aspects, process 1000 may include determining, based at least in part on receiving the COT sharing indication, whether the COT is associated with a first channel access type or a second channel access type, wherein the first channel access type is associated with aligning sidelink transmissions across a group of UEs, and wherein the second channel access type is associated with determining a transmission starting point for a sidelink communication based at least in part on a priority associated with the first UE (block 1020). For example, the first UE (e.g., using communication manager 140 and/or determination component 1208, depicted in FIG. 12) may determine, based at least in part on receiving the COT sharing indication, whether the COT is associated with a first channel access type or a second channel access type, as described above. In some aspects, the first channel access type is associated with aligning sidelink transmissions across a group of UEs. In some aspects, the second channel access type is associated with determining a transmission starting point for a sidelink communication based at least in part on a priority associated with the first UE.

As further shown in FIG. 10, in some aspects, process 1000 may include attempting to transmit a sidelink communication at the transmission starting point, wherein the transmission starting point corresponds to a common starting point utilized by the group of UEs based at least in part on the COT being associated with the first channel access type, or wherein the transmission starting point is selected from one or more transmission starting points in the COT based at least in part on the COT being associated with the second channel access type (block 1030). For example, the first UE (e.g., using communication manager 140 and/or transmission component 1204, depicted in FIG. 12) may attempt to transmit a sidelink communication at the transmission starting point, as described above. In some aspects, the transmission starting point corresponds to a common starting point utilized by the group of UEs based at least in part on the COT being associated with the first channel access type. In some aspects, the transmission starting point is selected from one or more transmission starting points in the COT based at least in part on the COT being associated with the second channel access type.

Process 1000 may include additional aspects, such as any single aspect or any combination of aspects described below and/or in connection with one or more other processes described elsewhere herein.

In a first aspect, determining whether the COT is associated with the first channel access type or the second channel access type comprises determining whether the COT is associated with the first channel access type or the second channel access type based at least in part on whether an indicator is included in the COT sharing indication.

In a second aspect, based at least in part on the COT being associated with the first channel access type, the indicator comprises a set of one or more bits indicating an entry in a table. The entry may indicate one or more of the transmission starting point, a cyclic prefix extension, an automatic gain control puncturing value, a channel access type, or a sensing duration.

In a third aspect, the COT is associated with the first channel access type based at least in part on the indicator being included in the COT sharing indication, or the COT is associated with the second channel access type based at least in part on the indicator not being included in the COT sharing indication.

In a fourth aspect, determining whether the COT is associated with the first channel access type or the second channel access type comprises determining whether the COT is associated with the first channel access type or the second channel access type based at least in part on a resource allocation associated with the COT.

In a fifth aspect, determining whether the COT is associated with the first channel access type or the second channel access type comprises determining whether the COT is associated with the first channel access type or the second channel access type based at least in part on a quantity of subchannels associated with the resource allocation.

In a sixth aspect, determining whether the COT is associated with the first channel access type or the second channel access type comprises determining whether the COT is associated with the first channel access type or the second channel access type based at least in part on a quantity of UEs associated with the COT.

In a seventh aspect, the COT sharing indication indicates a quantity of UEs that can share the COT and, based at least in part on the quantity of UEs being greater than a threshold quantity, the COT is associated with the second channel access type.

In an eighth aspect, the COT sharing indication is transmitted to the group of UEs and, based at least in part on a quantity of UEs included in the group of UEs being greater than a threshold quantity, the COT is associated with the second channel access type.

In a ninth aspect, determining whether the COT is associated with the first channel access type or the second channel access type comprises determining whether the COT is associated with the first channel access type or the second channel access type based at least in part on whether the COT is associated with a resource reservation.

In a tenth aspect, COT sharing indication is transmitted to the first UE and a third UE, and determining whether the COT is associated with the first channel access type or the second channel access type comprises determining, based at least in part on the COT being associated with the resource reservation that is associated with the third UE and that is within the COT, that the channel access type comprises the first channel access type.

In an eleventh aspect, process 1000 includes determining the transmission starting point based at least in part on a priority associated with the sidelink communication and a mapping of transmission starting points to one or more priorities associated with sidelink communications.

In a twelfth aspect, the one or more priorities may comprise a single priority or may comprise a plurality of priorities, wherein each priority, of the plurality of priorities, is mapped to a different transmission starting point.

In a thirteenth aspect, the first UE fails to decode the COT sharing indication or determines that a channel access procedure cannot be completed prior to a first transmission starting point, of the transmission starting points, that is mapped to the priority of the sidelink communication, and determining the transmission starting point comprises determining the transmission starting point based at least in part on the transmission starting point being mapped to a priority that is a same priority as the priority associated with the sidelink communication or to a priority that is a lower priority relative to the priority associated with the sidelink communication.

In a fourteenth aspect, the mapping comprises a first mapping based at least in part on the COT being associated with the first channel access type, and the mapping comprises a second mapping, that is different from the first mapping, based at least in part on the COT being associated with the second channel access type.

In a fifteenth aspect, the mapping is pre-configured in the first UE or the mapping is signaled by a network entity.

In a sixteenth aspect, process 1000 includes determining the transmission starting point based at least in part on a reference transmission.

In a seventeenth aspect, process 1000 includes determining the transmission starting point based at least in part on an end of a transmission of the COT sharing indication.

In an eighteenth aspect, process 1000 includes determining the transmission starting point based at least in part on an end of a transmission of a response to a communication transmitted by the second UE.

In a nineteenth aspect, the transmission starting point is located in a gap symbol and is achieved via cyclic prefix extension.

In a twentieth aspect, the transmission starting point is located in an AGC symbol and is achieved via AGC symbol puncturing.

In a twenty-first aspect, process 1000 includes determining the transmission starting point based at least in part on a first priority associated with the sidelink communication and a priority associated with the COT.

In a twenty-second aspect, the first UE determines that a channel access procedure cannot be completed prior to the transmission starting point, and process 1000 includes determining a next transmission starting point based at least in part on determining that the channel access procedure cannot be completed prior to the transmission staring point, and attempting to transmit the sidelink communication based at least in part on the next transmission starting point.

In a twenty-third aspect, the transmission starting point is determined based at least in part on a first mapping of transmission starting points to priorities associated with sidelink communications, and the next transmission starting point is determined based at least in part on a second mapping of transmission starting points to priorities associated with sidelink communications.

In a twenty-fourth aspect, a gap between a reference transmission and the next transmission starting point is greater than or equal to an amount of time associated with performing the channel access procedure.

In a twenty-fifth aspect, attempting to transmit the sidelink communication comprises performing sensing associated with the channel access procedure before a gap symbol or starting from the gap symbol.

In a twenty-sixth aspect, the transmission starting point is associated with a channel access sensing structure based at least in part on an amount of time between an end of a reference transmission and a time corresponding to the transmission starting point.

In a twenty-seventh aspect, the COT sharing indication indicates a slot indexing corresponding to the end of the reference transmission.

In a twenty-eighth aspect, the COT is associated with a resource reservation, wherein the COT is associated with the first channel access type based at least in part on the COT being associated with the resource reservation, and process 1000 includes determining the transmission starting point based at least in part on a transmission starting point associated with the resource reservation.

In a twenty-ninth aspect, process 1000 includes determining the transmission starting point associated with the resource reservation based at least in part on one or more of the transmission starting point associated with the resource reservation being indicated in sidelink control information associated with the resource reservation, a priority associated with the resource reservation, or a default transmission starting point associated with the first channel access type.

In a thirtieth aspect, the first channel access type is associated with a maximum quantity of subchannels that can be selected by the first UE for a transmission of the sidelink communication.

In a thirty-first aspect, the maximum quantity of subchannels is pre-configured in the first UE, signaled by a network entity via radio resource control (RRC) signaling, or signaled by the second UE via PC-5 RRC signaling.

In a thirty-second aspect, the COT sharing indication and inter-UE coordination signaling are utilized to indicate a set of preferred resources to be used by the first UE.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a first UE, in accordance with the present disclosure. Example process 1100 is an example where the first UE (e.g., UE 120i) performs operations associated with sensing structures and prioritization in COT sharing for sidelink in unlicensed spectrum.

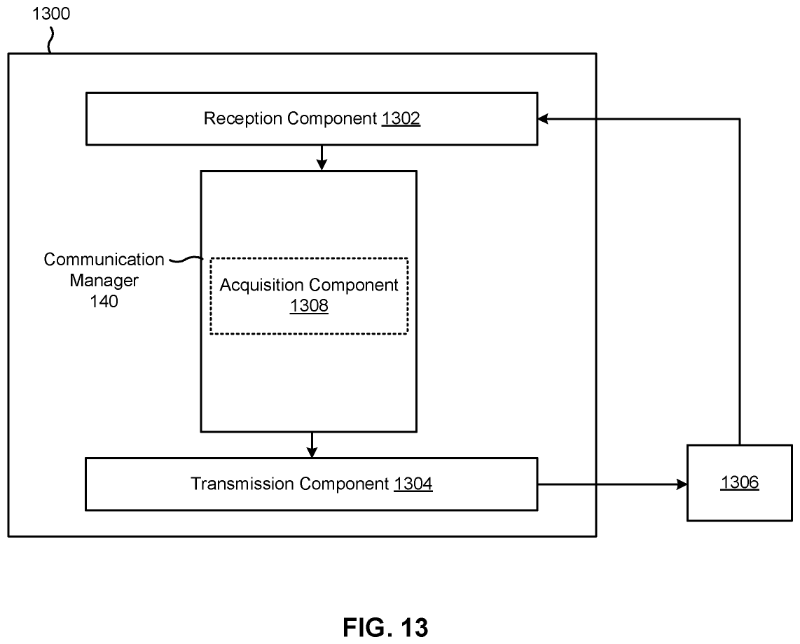

As shown in FIG. 11, in some aspects, process 1100 may include acquiring a COT (block 1110). For example, the first UE (e.g., using communication manager 140 and/or acquisition component 1308, depicted in FIG. 13) may acquire a COT, as described above.

As further shown in FIG. 11, in some aspects, process 1100 may include transmitting a COT sharing indication to a group of second UEs to enable the group of second UEs to utilize a portion of the COT, wherein the COT sharing indication indicates whether the COT is associated with a first channel access type or a second channel access type, wherein the first channel access type is associated with aligning sidelink transmissions across a group of UEs, and wherein the second channel access type is associated with determining a transmission starting point for a sidelink communication based at least in part on a priority associated with the first UE (block 1120). For example, the first UE (e.g., using communication manager 140 and/or transmission component 1304, depicted in FIG. 13) may transmit a COT sharing indication to a group of second UEs to enable the group of second UEs to utilize a portion of the COT, as described above. In some aspects, the first channel access type is associated with aligning sidelink transmissions across a group of UEs. In some aspects, the second channel access type is associated with determining a transmission starting point for a sidelink communication based at least in part on a priority associated with the first UE.

Process 1100 may include additional aspects, such as any single aspect or any combination of aspects described below and/or in connection with one or more other processes described elsewhere herein.

In a first aspect, an indicator is included in the COT sharing indication to indicate that the COT is associated with the first channel access type, and an absence of the indicator in the COT sharing indication indicates that the COT is associated with the second channel access type.

In a second aspect, the indicator is included in the COT sharing indication, and the indicator comprises a set of one or more bits indicating an entry in a table, wherein the entry indicates one or more of the transmission starting point, a cyclic prefix extension, an automatic gain control puncturing value, a channel access type, or a sensing duration.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a first UE (e.g., UE 120r), or a first UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 140. The communication manager 140 may include a determination component 1208, among other examples.

In some aspects, the apparatus 1200 may be configured to perform one or more operations described herein in connection with FIGS. 5-9. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the first UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the first UE described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the first UE described in connection with FIG. 2. In some aspects, the transmission component 1204 may be co-located with the reception component 1202 in a transceiver.

The reception component 1202 may receive a COT sharing indication from a second UE. The determination component 1208 may determine, based at least in part on receiving the COT sharing indication, whether the COT is associated with a first channel access type or a second channel access type, wherein the first channel access type is associated with aligning sidelink transmissions across a group of UEs, and wherein the second channel access type is associated with determining a transmission starting point for a sidelink communication based at least in part on a priority associated with the first UE. The transmission component 1204 may attempt to transmit a sidelink communication at the transmission starting point, wherein the transmission starting point corresponds to a common starting point utilized by the group of UEs based at least in part on the COT being associated with the first channel access type, or wherein the transmission starting point is selected from one or more transmission starting points in the COT based at least in part on the COT being associated with the second channel access type.

The determination component 1208 may determine the transmission starting point based at least in part on a priority associated with the sidelink communication and a mapping of transmission starting points to one or more priorities associated with sidelink communications.

The determination component 1208 may determine the transmission starting point based at least in part on a reference transmission.

The determination component 1208 may determine the transmission starting point based at least in part on an end of a transmission of the COT sharing indication.

The determination component 1208 may determine the transmission starting point based at least in part on an end of a transmission of a response to a communication transmitted by the second UE.

The determination component 1208 may determine the transmission starting point based at least in part on a first priority associated with the sidelink communication and a priority associated with the COT.

The determination component 1208 may determine the transmission starting point associated with the resource reservation based at least in part on one or more of the transmission starting point associated with the resource reservation being indicated in sidelink control information associated with the resource reservation, a priority associated with the resource reservation, or a default transmission starting point associated with the first channel access type.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a first UE (e.g., UE 120i), or a first UE may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 140. The communication manager 140 may include an acquisition component 1308, among other examples.

In some aspects, the apparatus 1300 may be configured to perform one or more operations described herein in connection with FIGS. 5-9. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the first UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the first UE described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the first UE described in connection with FIG. 2. In some aspects, the transmission component 1304 may be co-located with the reception component 1302 in a transceiver.

The acquisition component 1308 may acquire a COT. The transmission component 1304 may transmit a COT sharing indication to a group of second UEs to enable the group of second UEs to utilize a portion of the COT, wherein the COT sharing indication indicates whether the COT is associated with a first channel access type or a second channel access type, wherein the first channel access type is associated with aligning sidelink transmissions across a group of UEs, and wherein the second channel access type is associated with determining a transmission starting point for a sidelink communication based at least in part on a priority associated with the first UE.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:
Aspect 1: A method of wireless communication performed by an apparatus of a first UE (e.g., UE 120r), comprising: receiving a COT sharing indication from a second UE; determining, based at least in part on receiving the COT sharing indication, whether the COT is associated with a first channel access type or a second channel access type, wherein the first channel access type is associated with aligning sidelink transmissions across a group of UEs, and wherein the second channel access type is associated with determining a transmission starting point for a sidelink communication based at least in part on a priority associated with the first UE; and attempting to transmit a sidelink communication at the transmission starting point, wherein the transmission starting point corresponds to a common starting point utilized by the group of UEs based at least in part on the COT being associated with the first channel access type, or wherein the transmission starting point is selected from one or more transmission starting points in the COT based at least in part on the COT being associated with the second channel access type.
Aspect 2: The method of Aspect 1, wherein determining whether the COT is associated with the first channel access type or the second channel access type comprises: determining whether the COT is associated with the first channel access type or the second channel access type based at least in part on whether an indicator is included in the COT sharing indication.
Aspect 3: The method of Aspect 2, wherein, based at least in part on the COT being associated with the first channel access type, the indicator comprises a set of one or more bits indicating an entry in a table, wherein the entry indicates one or more of the transmission starting point, a cyclic prefix extension, an automatic gain control puncturing value, a channel access type, or a sensing duration.
Aspect 4: The method of Aspect 2, wherein the COT is associated with the first channel access type based at least in part on the indicator being included in the COT sharing indication, or wherein the COT is associated with the second channel access type based at least in part on the indicator not being included in the COT sharing indication.
Aspect 5: The method of one or more of Aspects 1 through 4, wherein determining whether the COT is associated with the first channel access type or the second channel access type comprises: determining whether the COT is associated with the first channel access type or the second channel access type based at least in part on a resource allocation associated with the COT.
Aspect 6: The method of Aspect 5, wherein determining whether the COT is associated with the first channel access type or the second channel access type comprises: determining whether the COT is associated with the first channel access type or the second channel access type based at least in part on a quantity of subchannels associated with the resource allocation.
Aspect 7: The method of one or more of Aspects 1 through 6, wherein determining whether the COT is associated with the first channel access type or the second channel access type comprises: determining whether the COT is associated with the first channel access type or the second channel access type based at least in part on a quantity of UEs associated with the COT.
Aspect 8: The method of one or more of Aspects 1 through 7, wherein the COT sharing indication indicates a quantity of UEs that can share the COT, and wherein, based at least in part on the quantity of UEs being greater than a threshold quantity, the COT is associated with the second channel access type.
Aspect 9: The method of one or more of Aspects 1 through 8, wherein the COT sharing indication is transmitted to the group of UEs, and wherein, based at least in part on a quantity of UEs included in the group of UEs being greater than a threshold quantity, the COT is associated with the second channel access type.
Aspect 10: The method of one or more of Aspects 1 through 9, wherein determining whether the COT is associated with the first channel access type or the second channel access type comprises: determining whether the COT is associated with the first channel access type or the second channel access type based at least in part on whether the COT is associated with a resource reservation.
Aspect 11: The method of Aspect 10, wherein COT sharing indication is transmitted to the first UE and a third UE, and wherein determining whether the COT is associated with the first channel access type or the second channel access type comprises: determining, based at least in part on the COT being associated with the resource reservation that is associated with the third UE and that is within the COT, that the channel access type comprises the first channel access type.
Aspect 12: The method of one or more of Aspects 1 through 11, further comprising: determining the transmission starting point based at least in part on a priority associated with the sidelink communication and a mapping of transmission starting points to one or more priorities associated with sidelink communications.
Aspect 13: The method of Aspect 12, wherein the one or more priorities is a single priority.
Aspect 14: The method of Aspect 12, wherein the one or more priorities comprise a plurality of priorities, and wherein each priority, of the plurality of priorities, is mapped to a different transmission starting point.
Aspect 15: The method of Aspect 12, wherein the first UE fails to decode the COT sharing indication or determines that a channel access procedure cannot be completed prior to a first transmission starting point, of the transmission starting points, that is mapped to the priority of the sidelink communication, and wherein determining the transmission starting point comprises: determining the transmission starting point based at least in part on the transmission starting point being mapped to a priority that is a same priority as the priority associated with the sidelink communication or to a priority that is a lower priority relative to the priority associated with the sidelink communication.
Aspect 16: The method of Aspect 12, wherein the mapping comprises a first mapping based at least in part on the COT being associated with the first channel access type, and the mapping comprises a second mapping, that is different from the first mapping, based at least in part on the COT being associated with the second channel access type.
Aspect 17: The method of Aspect 12, wherein the mapping is pre-configured in the first UE or the mapping is signaled by a network entity.
Aspect 18: The method of one or more of Aspects 1 through 17, further comprising: determining the transmission starting point based at least in part on a reference transmission.
Aspect 19: The method of one or more of Aspects 1 through 18, further comprising: determining the transmission starting point based at least in part on an end of a transmission of the COT sharing indication.
Aspect 20: The method of one or more of Aspects 1 through 19, further comprising: determining the transmission starting point based at least in part on an end of a transmission of a response to a communication transmitted by the second UE.
Aspect 21: The method of one or more of Aspects 1 through 20, wherein the transmission starting point is located in a gap symbol and is achieved via cyclic prefix extension.
Aspect 22: The method of one or more of Aspects 1 through 21, wherein the transmission starting point is located in an AGC symbol and is achieved via AGC symbol puncturing.
Aspect 23: The method of one or more of Aspects 1 through 22, further comprising: determining the transmission starting point based at least in part on a first priority associated with the sidelink communication and a priority associated with the COT.
Aspect 24: The method of one or more of Aspects 1 through 23, wherein the first UE determines that a channel access procedure cannot be completed prior to the transmission starting point, and wherein the method further comprises: determining a next transmission starting point based at least in part on determining that the channel access procedure cannot be completed prior to the transmission staring point; and attempting to transmit the sidelink communication based at least in part on the next transmission starting point.
Aspect 25: The method of Aspect 24, wherein the transmission starting point is determined based at least in part on a first mapping of transmission starting points to priorities associated with sidelink communications, and the next transmission starting point is determined based at least in part on a second mapping of transmission starting points to priorities associated with sidelink communications.
Aspect 26: The method of Aspect 24, wherein a gap between a reference transmission and the next transmission starting point is greater than or equal to an amount of time associated with performing the channel access procedure.
Aspect 27: The method of Aspect 24, wherein attempting to transmit the sidelink communication comprises: performing sensing associated with the channel access procedure before a gap symbol or starting from the gap symbol.
Aspect 28: The method of one or more of Aspects 1 through 27, wherein the transmission starting point is associated with a channel access sensing structure based at least in part on an amount of time between an end of a reference transmission and a time corresponding to the transmission starting point.
Aspect 29: The method of Aspect 26, wherein the COT sharing indication indicates a slot indexing corresponding to the end of the reference transmission.
Aspect 30: The method of one or more of Aspects 1 through 29, wherein the COT is associated with a resource reservation, wherein the COT is associated with the first channel access type based at least in part on the COT being associated with the resource reservation, and wherein the method further comprises: determining the transmission starting point based at least in part on a transmission starting point associated with the resource reservation.
Aspect 31: The method of Aspect 30, further comprising: determining the transmission starting point associated with the resource reservation based at least in part on one or more of: the transmission starting point associated with the resource reservation being indicated in sidelink control information associated with the resource reservation, a priority associated with the resource reservation, or a default transmission starting point associated with the first channel access type.
Aspect 32: The method of one or more of Aspects 1 through 31, wherein the first channel access type is associated with a maximum quantity of subchannels that can be selected by the first UE for a transmission of the sidelink communication.
Aspect 33: The method of Aspect 32, wherein the maximum quantity of subchannels is pre-configured in the first UE, signaled by a network entity via radio resource control (RRC) signaling, or signaled by the second UE via PC-5 RRC signaling.
Aspect 34: The method of Aspect 32, wherein the COT sharing indication and inter-UE coordination signaling are utilized to indicate a set of preferred resources to be used by the first UE.
Aspect 35: A method of wireless communication performed by an apparatus of a first UE (e.g., UE 120i), comprising: acquiring a COT; and transmitting a COT sharing indication to a group of second UEs to enable the group of second UEs to utilize a portion of the COT, wherein the COT sharing indication indicates whether the COT is associated with a first channel access type or a second channel access type, wherein the first channel access type is associated with aligning sidelink transmissions across a group of UEs, and wherein the second channel access type is associated with determining a transmission starting point for a sidelink communication based at least in part on a priority associated with the first UE.
Aspect 36: The method of Aspect 35, wherein an indicator is included in the COT sharing indication to indicate that the COT is associated with the first channel access type, and wherein an absence of the indicator in the COT sharing indication indicates that the COT is associated with the second channel access type.
Aspect 37: The method of Aspect 36, wherein the indicator is included in the COT sharing indication, and wherein the indicator comprises a set of one or more bits indicating an entry in a table, wherein the entry indicates one or more of the transmission starting point, a cyclic prefix extension, an automatic gain control puncturing value, a channel access type, or a sensing duration.
Aspect 38: An apparatus for wireless communication at a device, comprising a processor; memory coupled with the processor; and instructions stored in the memory and executable by the processor to cause the apparatus to perform the method of one or more of Aspects 1 through 34.
Aspect 39: A device for wireless communication, comprising a memory and one or more processors coupled to the memory, the one or more processors configured to perform the method of one or more of Aspects 1 through 34.
Aspect 40: An apparatus for wireless communication, comprising at least one means for performing the method of one or more of Aspects 1 through 34.
Aspect 41: A non-transitory computer-readable medium storing code for wireless communication, the code comprising instructions executable by a processor to perform the method of one or more of Aspects 1 through 34.
Aspect 42: A non-transitory computer-readable medium storing a set of instructions for wireless communication, the set of instructions comprising one or more instructions that, when executed by one or more processors of a device, cause the device to perform the method of one or more of Aspects 1 through 34.
Aspect 43: An apparatus for wireless communication at a device, comprising a processor; memory coupled with the processor; and instructions stored in the memory and executable by the processor to cause the apparatus to perform the method of one or more of Aspects 35 through 37.
Aspect 44: A device for wireless communication, comprising a memory and one or more processors coupled to the memory, the one or more processors configured to perform the method of one or more of Aspects 35 through 37.
Aspect 45: An apparatus for wireless communication, comprising at least one means for performing the method of one or more of Aspects 35 through 37.
Aspect 46: A non-transitory computer-readable medium storing code for wireless communication, the code comprising instructions executable by a processor to perform the method of one or more of Aspects 35 through 37.
Aspect 47: A non-transitory computer-readable medium storing a set of instructions for wireless communication, the set of instructions comprising one or more instructions that, when executed by one or more processors of a device, cause the device to perform the method of one or more of Aspects 35 through 37.
The foregoing disclosure provides illustration and description but is not intended to be exhaustive or to limit the aspects to the precise forms disclosed.

Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method of wireless communication performed by an apparatus of a first user equipment (UE), comprising:
receiving a channel occupancy time (COT) sharing indication from a second UE;
determining, based at least in part on receiving the COT sharing indication, whether the COT is associated with a first channel access type or a second channel access type, wherein the first channel access type is associated with aligning sidelink transmissions across a group of UEs, and wherein the second channel access type is associated with determining a transmission starting point for a sidelink communication based at least in part on a priority associated with the first UE; and
attempting to transmit a sidelink communication at the transmission starting point, wherein the transmission starting point corresponds to a common starting point utilized by the group of UEs based at least in part on the COT being associated with the first channel access type, or wherein the transmission starting point is selected from one or more transmission starting points in the COT based at least in part on the COT being associated with the second channel access type.

2. The method of claim 1, wherein determining whether the COT is associated with the first channel access type or the second channel access type comprises:
determining whether the COT is associated with the first channel access type or the second channel access type based at least in part on whether an indicator is included in the COT sharing indication.

3-8. (canceled)

9. The method of claim 1, wherein the COT sharing indication is transmitted to the group of UEs, and
wherein, based at least in part on a quantity of UEs included in the group of UEs being greater than a threshold quantity, the COT is associated with the second channel access type.

10. The method of claim 1, wherein determining whether the COT is associated with the first channel access type or the second channel access type comprises:
determining whether the COT is associated with the first channel access type or the second channel access type based at least in part on whether the COT is associated with a resource reservation.

11. The method of claim 10, wherein the COT sharing indication is transmitted to the first UE and a third UE, and wherein determining whether the COT is associated with the first channel access type or the second channel access type comprises:
determining, based at least in part on the COT being associated with the resource reservation that is associated with the third UE and that is within the COT, that the COT is associated with the first channel access type.

12. The method of claim 1, further comprising:
determining the transmission starting point based at least in part on a priority associated with the sidelink communication and a mapping of transmission starting points to one or more priorities associated with sidelink communications.

13-20. (canceled)

21. The method of claim 1, wherein the transmission starting point is located in a gap symbol and is achieved via cyclic prefix extension.

22. The method of claim 1, wherein the transmission starting point is located in an automatic gain control (AGC) symbol and is achieved via AGC symbol puncturing.

23-29. (canceled)

30. The method of claim 1, wherein the COT is associated with a resource reservation, wherein the COT is associated with the first channel access type based at least in part on the COT being associated with the resource reservation, and wherein the method further comprises:
determining the transmission starting point based at least in part on a transmission starting point associated with the resource reservation.

31. The method of claim 30, further comprising:
determining the transmission starting point associated with the resource reservation based at least in part on one or more of:
the transmission starting point associated with the resource reservation being indicated in sidelink control information associated with the resource reservation,
a priority associated with the resource reservation, or
a default transmission starting point associated with the first channel access type.

32-37. (canceled)

38. An apparatus of a first user equipment (UE) for wireless communication, comprising:
a memory; and
one or more processors, coupled to the memory, configured to:
receive a channel occupancy time (COT) sharing indication from a second UE;
determine, based at least in part on receiving the COT sharing indication, whether the COT is associated with a first channel access type or a second channel access type,
wherein the first channel access type is associated with aligning sidelink transmissions across a group of UEs, and
wherein the second channel access type is associated with determining a transmission starting point for a sidelink communication based at least in part on a priority associated with the first UE; and
attempt to transmit a sidelink communication at the transmission starting point,
wherein the transmission starting point corresponds to a common starting point utilized by the group of UEs based at least in part on the COT being associated with the first channel access type, or
wherein the transmission starting point is selected from one or more transmission starting points in the COT based at least in part on the COT being associated with the second channel access type.

39-43. (canceled)

44. The apparatus of claim 38, wherein the COT sharing indication is transmitted to the group of UEs, and
wherein the one or more processors are configured to determine that the COT is associated with the second channel access type based at least in part on a quantity of UEs included in the group of UEs being greater than a threshold quantity.

45. The apparatus of claim 38, wherein the one or more processors are configured to determine whether the COT is associated with the first channel access type or the second channel access type by determining whether the COT is associated with the first channel access type or the second channel access type based at least in part on whether the COT is associated with a resource reservation.

46. The apparatus of claim 45, wherein the COT sharing indication is transmitted to the first UE and a third UE, and wherein the one or more processors are configured to determine whether the COT is associated with the first channel access type or the second channel access type by determining, based at least in part on the COT being associated with the resource reservation that is associated with the third UE and that is within the COT, that the COT is associated with the first channel access type.

47. The apparatus of claim 38, wherein the one or more processors are further configured to determine the transmission starting point based at least in part on a priority associated with the sidelink communication and a mapping of transmission starting points to one or more priorities associated with sidelink communications.

48. The apparatus of claim 38, wherein the transmission starting point is located in a gap symbol and is achieved via cyclic prefix extension.

49. The apparatus of claim 38, wherein the transmission starting point is located in an automatic gain control (AGC) symbol and is achieved via AGC symbol puncturing.

50. The apparatus of claim 38, wherein the COT is associated with a resource reservation, wherein the COT is associated with the first channel access type based at least in part on the COT being associated with the resource reservation, and wherein the one or more processors are further configured to determine the transmission starting point based at least in part on a transmission starting point associated with the resource reservation.

51. The apparatus of claim 50, wherein the one or more processors are further configured to:
determine the transmission starting point associated with the resource reservation based at least in part on one or more of:
the transmission starting point associated with the resource reservation being indicated in sidelink control information associated with the resource reservation,
a priority associated with the resource reservation, or
a default transmission starting point associated with the first channel access type.

52. A first apparatus for wireless communication, comprising:
means for receiving a channel occupancy time (COT) sharing indication from a second apparatus;
means for determining, based at least in part on receiving the COT sharing indication, whether the COT is associated with a first channel access type or a second channel access type, wherein the first channel access type is associated with aligning sidelink transmissions across a group of apparatuses, and wherein the second channel access type is associated with determining a transmission starting point for a sidelink communication based at least in part on a priority associated with the first apparatus; and
means for attempting to transmit a sidelink communication at the transmission starting point, wherein the transmission starting point corresponds to a common starting point utilized by the group of apparatuses based at least in part on the COT being associated with the first channel access type, or wherein the transmission starting point is selected from one or more transmission starting points in the COT based at least in part on the COT being associated with the second channel access type.
